(19) United States
(12) Patent Application Publication
(10) Pub. No.: US 2014/0180785 A1
(43) Pub. Date: Jun. 26, 2014

(54) REPORTING OUT-OF-STOCK ITEMS

(71) Applicants: STUART ARGUE, PALO ALTO, CA (US); ANTHONY EMILE MARCAR, SAN FRANCISCO, CA (US)

(72) Inventors: STUART ARGUE, PALO ALTO, CA (US); ANTHONY EMILE MARCAR, SAN FRANCISCO, CA (US)

(73) Assignee: WAL-MART STORES, INC., BENTONVILLE, AR (US)

(21) Appl. No.: 13/723,131

(22) Filed: Dec. 20, 2012

(51) Int. Cl. G06Q 30/02

(52) U.S. Cl. CPC G06Q 30/0223
USPC 705/14.24

(57) ABSTRACT

Systems and methods are disclosed herein for maintaining product available on store shelves. An optical code is positioned adjacent a location where a product is located when in stock. A customer finding the product to be out of stock may scan the code and report this fact. A computer system receives the notification and may transmit a message to an employee computing device. Notice of restocking or unavailability may be transmitted from the employee computing device and subsequently reported to a customer computing device. A location of the user computing device may be reported to an employee to facilitate hand delivery of the product if available. Where inventory is not available at a store, notice of availability at a proximate store may be transmitted to the customer computing device. An incentive in the form of a promotion or points may be assigned to notifying customers.

### BACKGROUND

1. Field of the Invention

This invention relates to systems and methods for maintaining a stock of products on shelves in a retail environment.

2. Background of the Invention

It can be a frustrating to shoppers to go to a store and find that a product on a shopping list is out of stock. On the other hand, the modern “super store” may include many hundreds of different products. Although it can be relatively easy to maintain inventories of a product based on daily sales and historical usage, maintaining stock of a product on a shelf can be difficult due to limited shelf space. Inasmuch as a store may desire to provide a wide variety of items for sale, the amount of shelf space allocated for each product may only allow for a small quantity. The shelved quantity may be exhausted by unpredictable events, such as temporary spikes in demand due to a customer stocking up on the product, a successful advertising campaign, or some other other factor. For a large store, it may be expensive to maintain sufficient staff to constantly monitor every product to avoid running out of stock.

The systems and methods described herein provide an improved approach for maintaining stock of products on shelves.

### BRIEF DESCRIPTION OF THE DRAWINGS

In order that the advantages of the invention will be readily understood, a more particular description of the invention will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a system suitable for performing methods in accordance with embodiments of the invention;

FIG. 2 is a block diagram of a computing device suitable for implementing embodiments of the invention;

FIG. 3 is a schematic diagram of a shelf using which the methods in accordance with the invention may be implemented;

FIG. 4 is a process flow diagram for reporting an out-of-stock product in accordance with an embodiment of the invention;

FIG. 5A is an example interface for a customer computing device in accordance with an embodiment of the invention;

FIG. 5B is an alternative example interface for a user computing device in accordance with an embodiment of the invention;

FIG. 6 is a process flow diagram of a method for characterizing the effectiveness of in-store advertisements in accordance with an embodiment of the invention;

FIG. 7 is an example interface for an employee computing device in accordance with an embodiment of the invention; and

FIG. 8 is a process flow diagram of a method for transmitting restock notifications in accordance with an embodiment of the invention.

### DETAILED DESCRIPTION

It will be readily understood that the components of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

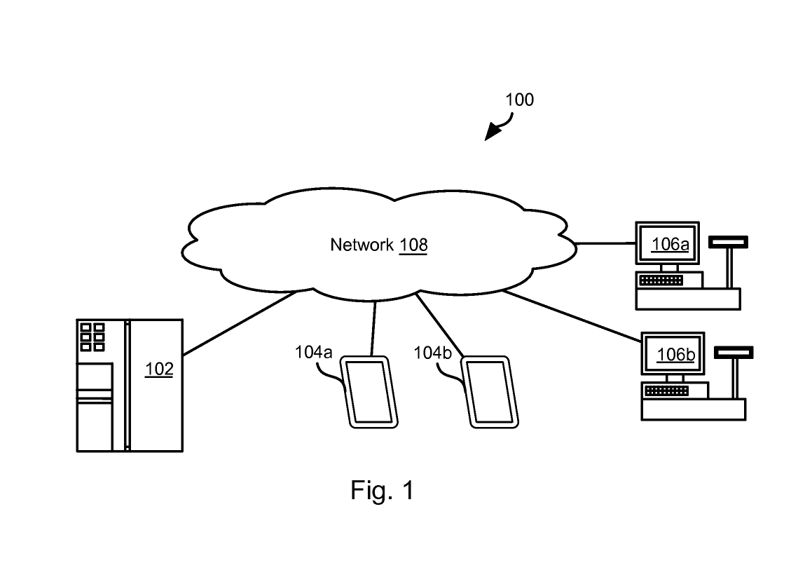

FIG. 1 illustrates a system 100 in which methods described hereinbelow may be implemented. The system 100 may include a server system 102 that may be embodied as one or more server computers each including one or more processors that are in data communication with one another. The server system 102 may be in data communication with one or more customer computers 104a, 104b and one or more point of sale (POS) devices 106a, 106b. In the methods disclosed herein, the customer computers 104a, 104b are advantageously mobile devices such as a mobile phone or tablet computer. As known in the art, many mobile phones and tablet computers also include cameras that can be used to scan optical codes such as barcodes, two-dimensional bar codes (e.g. quick response (QR) codes), or textual information. In some embodiments, some or all of the methods disclosed herein may be performed using a desktop computer or any other computing device as the customer computer 104a, 104b. For purposes of this disclosure, discussion of communication with a user or entity or activity performed by the user or entity may be interpreted as communication with a computer 104a, 104b associated with the user or entity or activity taking place on a computer associated with the user or entity. A POS 106a-106b may be located within a store and may be part of a POS network. In some embodiments, a POS 106a, 106b may be operable to process online transactions. In some embodiments, separate computers of the server system 102 may handle communication with the customer computers 104a, 104b and POS 106a, 106b.

Some or all of the server 102, customer devices 104a, 104b, and POS 106 may communicate with one another by means of a network 108. The network 108 may be embodied as a peer-to-peer wireless connection between devices, a connection through a local area network (LAN), WiFi network, the Internet, or any other communication medium or system.

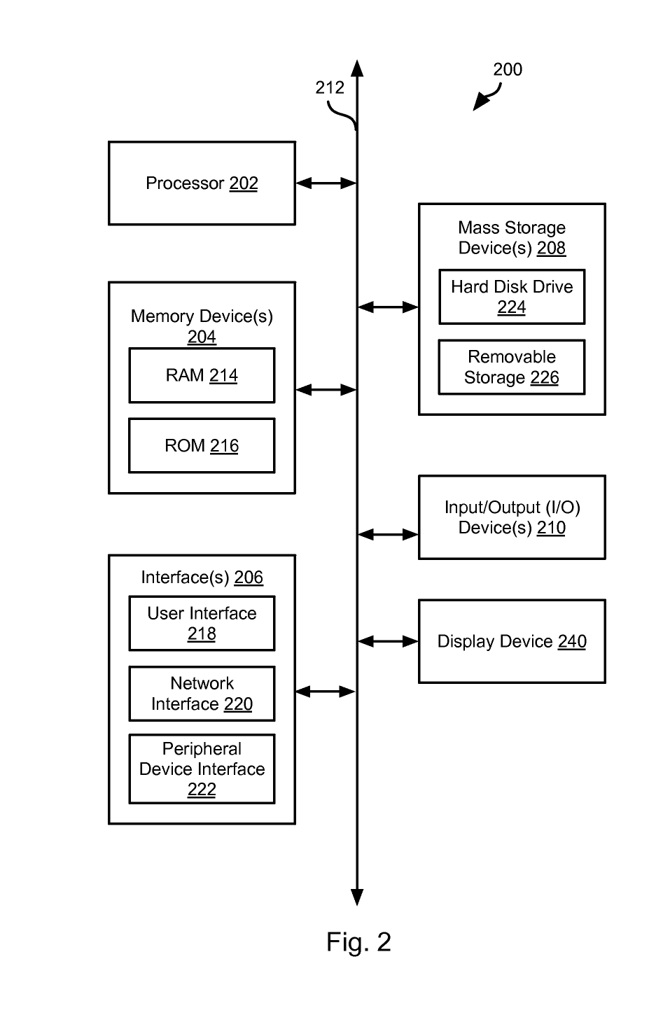

FIG. 2 is a block diagram illustrating an example computing device 200. Computing device 200 may be used to perform various procedures, such as those discussed herein. A control module 100 and cart control module 124 may include some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

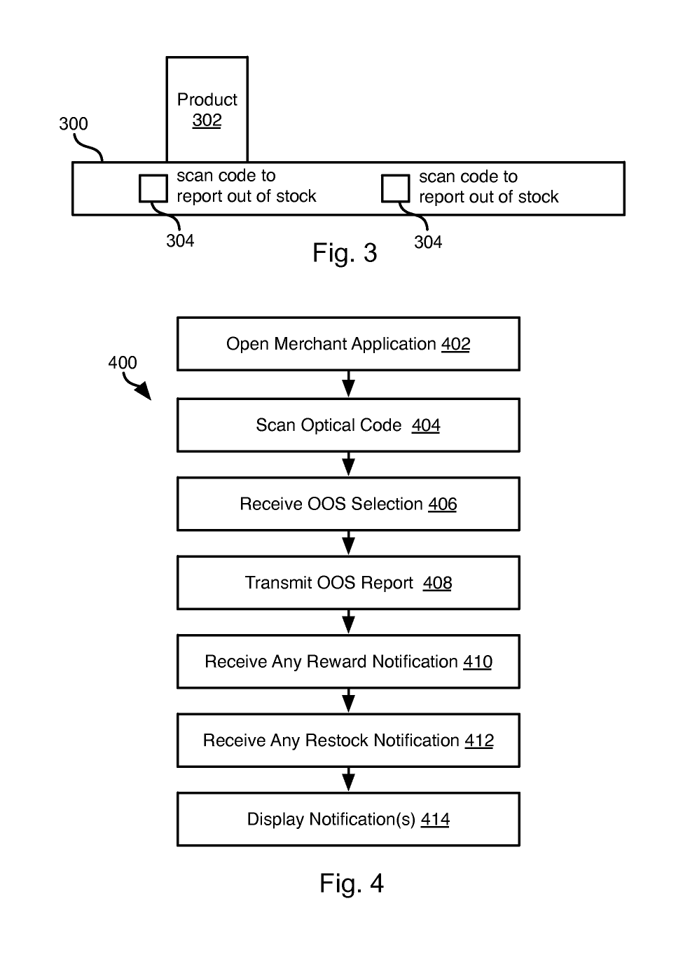

FIG. 3 illustrates a shelf 300 suitable for use in accordance with the methods described herein. A shelf 300 may bear one or more products 302 as well as one or more optical codes 304. Each optical code 304 may correspond to a product 302 located on the shelf at the position of the optical code 304 or otherwise adjacent the optical code 304. The shelf 300 may be located anywhere in a store including within a display case, refrigerated display, or any other location. In some embodiments, the shelf 300 may be embodied as a hook or other structure supporting a product when in stock and having an optical code 304 secured thereto or positioned adjacent thereto. In some embodiments, a product in stock may rest on a pedestal or the floor. In such embodiments, the optical code 304 corresponding to the product may be secured to the pedestal or floor or may be mounted on a sign or other structure positioned adjacent the in-stock location for the product.

An optical 304 may be a bar code, two-dimensional bar code (e.g., quick response (QR) code), or any other optical code. The optical code 304 may encode a product identifier of the product corresponding to the optical code. In some embodiments, the optical code 304 may encode an “address” that uniquely identifies the shelf and position on a shelf, or other location in a store. The address may additionally include an address or other identifier of the store. A database may include mappings of an address to a product currently stocked at that address. Accordingly, the address of the optical code 304 in combination with the mapping may be used to obtain an identifier of the product currently corresponding to the optical code 304. In this manner, a store is not required to mount new optical codes 304 each time the stocking location of products is changed—only the mapping in the database need change. The optical code 304 may encode other information corresponding to an associated product that may be used for purposes other than the embodiments disclosed herein, such as a uniform resource locator (URL) for a web site providing information such as product reviews, product description, or other information.

In some embodiments, the optical code 304 may have one or more instructions displayed adjacent thereto, such as instruction that says “scan code to report this item out of stock,” “scan code to report this item out of stock or retrieve product information,” or some other message. In some embodiments, the optical code 304 or any instructions may be displayed on an electronic screen that is independently addressable to change the information displayed thereon. In such embodiments, a mapping between an address of the electronic screen and a product may be used to select information to display on the electronic screen, e.g. the optical code 304 corresponding to the product corresponding to the address of the electronic screen.

FIG. 4 illustrates a method 400 that may be executed by a customer computing device 104a, 104b or executed elsewhere with an interface provided on the customer computing device 104a, 104b. The method 400 may include opening a merchant application 402 and scanning 404 the optical code corresponding to a product. In some embodiment, the optical code for a product may encode a URL, such that scanning 404 of the code invokes a browser or other application in which the remaining steps of the method 400 may be executed. Alternatively, scanning 404 of the optical code within the operating context of a merchant application may invoke the remaining steps of the method 400. In some embodiments, a customer may type in a product identifier to a an interface, such as a merchant application, rather than scanning an optical code in order to select a product for processing in accordance with the methods described herein.

For a product identified by scanning a code or by some other means, the method 400 may include receiving 406 a selection of an interface element that indicates the product is out of stock. In some embodiments, the method 400 may be executed exclusively to indicate that a product is out of stock, such that no input or instruction is required to indicate that the product is out of stock.

The method 400 may include transmitting 408 a report that the product is out of stock. Transmission 408 of the report may be invoked by simply scanning 404 of the optical code or otherwise selecting or identifying the product within a merchant application. Transmission 408 of the report may be invoked by explicit selection of an interface element or link in a web page by a customer on the customer computing device 104a, 104b.

In some embodiments, an incentive may be provided to customers for reporting that a product is out of stock in order to temper any annoyance a customer might experience due to failure to find a desired product. In many instances, merely having a ready means for reporting a product out of stock and knowing that action will be taken may by itself reduce frustration. Accordingly, the methods disclosed herein may be implemented without providing an explicit incentive or reward. An incentive may also be provided in order to encourage action by the customer. In such embodiments, a notification of a reward assigned in response to the report may be received 410. The reward may be any incentive known in the art such as discounts, free products, points for use in a game or other context, or any other promotion that can be employed in a retail context. In some embodiments, a reward or incentive may include entering the customer into a drawing or lottery for a prize. The number of entries into the raffle or lottery may be increased in accordance with the number of validated notifications of out of stock products.

In some embodiments, the method may include receiving 412 a restock notification 412. The restock notification 412 may indicate that a product has been restocked, is available for pick up at a cash register or other location, or can be found at a nearby store. The restock notification may be transmitted at any time after reporting a product out of stock. For example, if a delivery occurs hours or days after a product is reported out of stock, a notice may be transmitted and received 412 once the product is available for purchase.

Some or all of these notifications, if received 410, 412, may be displayed 414 on the customer computing device 104a, 104b. Receipt 410, 412 of a notification may include invoking a ring, vibration, or other tangible, visible or audible alert for the customer.

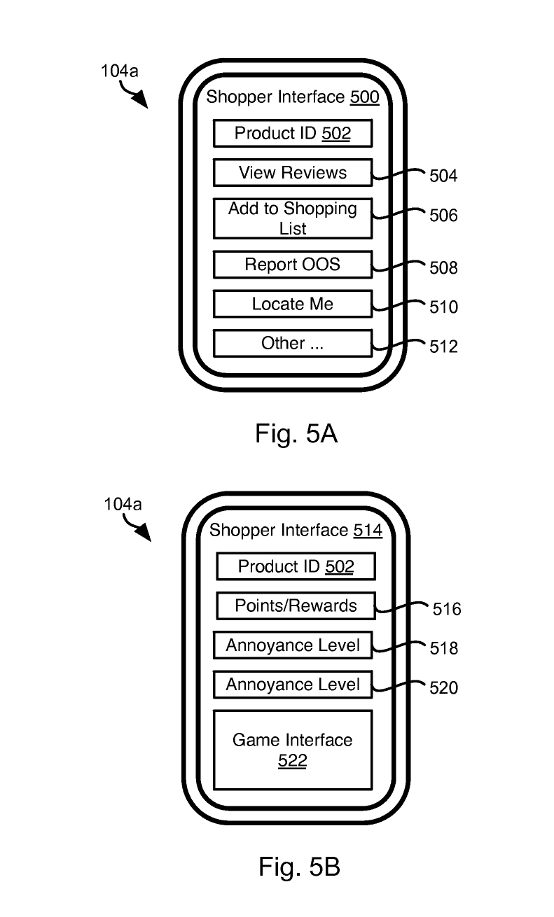

FIGS. 5A and 5B illustrate interfaces that may be displayed on a customer computing device 104a during performance of the method 400. The illustrated interfaces may be displayed by an application installed on the customer computing device 104a The illustrated interfaces may be displayed in a web page rendered on the customer computing device, where the web page is retrieved in response to scanning an optical code 304 corresponding to the product or otherwise invoked by the customer with respect to a product.

Referring specifically to FIG. 5A, a shopper interface 500 may include a product identifier 502 identifying the product corresponding to the scanned optical code 304 or otherwise input by the customer. The product identifier 502 may include text or images corresponding to the product. The interface 500 may include interface elements for invoking one or more actions with respect to the product. For example, some or all of the listed interface elements 504-512 may be included in a shopping interface 500.

For example, an interface element 504 may invoke display of reviews of the product or other information relating to a product. An interface element 506 may invoke addition of the product to a shopping list of the customer that is maintained on the customer device 104a or in a customer account maintained or accessed by a server system 102.

An interface element 508 may invoke transmission of a report that the product is out of stock, as described above with respect to the method 400. In some embodiments, a customer may allow or instruct a merchant to locate the customer in order to deliver the product to the customer. For example, if the product is available in a store but not currently stocked on the shelf, a store employee may retrieve the product from storage and bring the product to the customer before the customer checks out or otherwise leaves the store. In some embodiments, in order to compensate for the annoyance of the product being out of stock, the store may deliver the product to the notifying customer's home. Accordingly, the interface element 510 may invoke transmission of an instruction or authorization to perform one or more of these functions. One or more other user interface elements 512 may invoke other actions with respect to the product or any other action.

Referring to FIG. 5B, as noted above, in some embodiments a merchant may provide incentives to customers to report a product out of stock. Accordingly, a shopper interface 514 may be provided to view and otherwise manage these incentives. The incentives provided for reporting a product out of stock may be the same or otherwise combined with incentives for other activity. The shopping interface 514 may include the product identifier 502 identifying the product for which an incentive has been provided. The interface 514 may include an interface element 516 displaying or invoking display of points or other rewards associated with a customer associated with the user computing device 104a.

The interface 514 may include an interface element 518 to receive, or invoke an interface for receiving, an annoyance level. The interface element 518 may, for example, enable a customer to select an emoticon indicating how important the out-of-stock product was to the customer or how time sensitive the product is to the customer. The annoyance level may be used by the merchant to determine how important timely access of a product is to a customer. This information may be used by a merchant to identify critical products that should receive special attention to keep in stock.

In some embodiments, rewards or incentives provided to a customer may include points or other credits that may be used in the context of a game. Accordingly, an interface 514 may include a game interface 522 for interacting with game logic or invoking display of an interface for interacting with game logic. The games, type of games, manner in which points are used or accumulated, and other aspects of the game interface 522 and associated game may be in accordance with any electronic game known in the art, including interactive on-line games including multiple users. The game logic access by means of the interface 522 may execute on a server system 102 owned or controlled by a merchant or a game logic executing on a server system operated by some other entity.

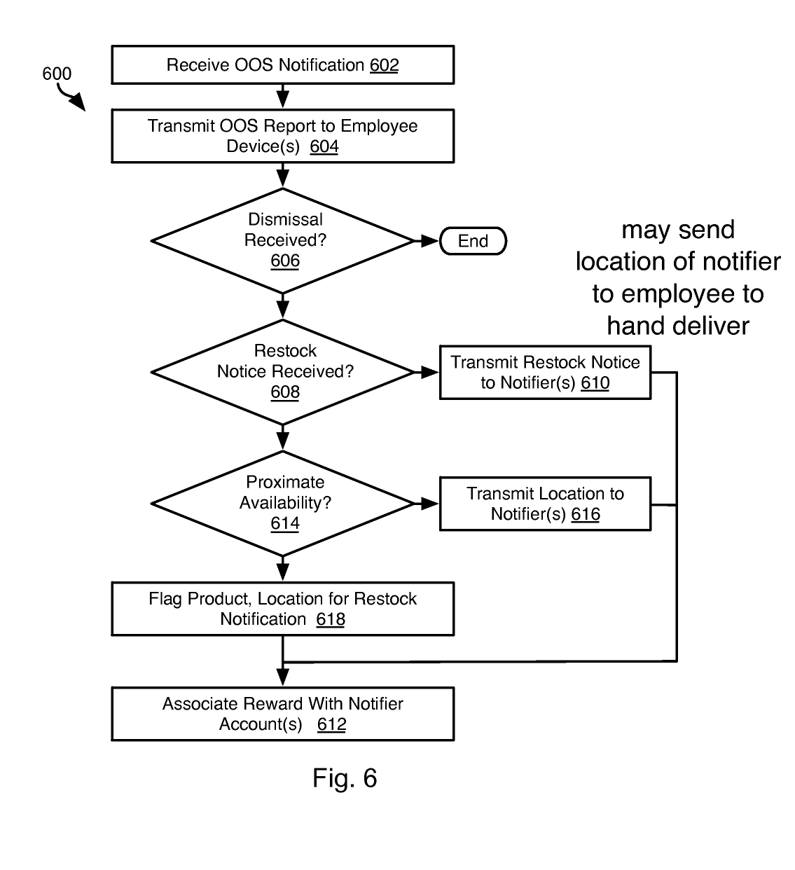

FIG. 6 illustrates a method 600 that may be executed by a server system 102 or on some other device with an interface provided to a server system 102. The method 600 may be executed by a computer system local to a specific store or stores within a limited geographic region.

The method 600 may include receiving 602 an out-of-stock (OOS) notification that identifies a product. A report of the OOS notification may be transmitted 604 to one or more employee devices. The report may include information such as a product identifier, a location of any available inventory for the product corresponding to the product, or other information. The method 600 may include evaluating 606 whether dismissal of the report has been received from one or more computing devices. In some embodiments, measures may be taken to avoid fraudulent reports. Accordingly, an employee that verifies that a product is actually stocked at its proper location may provide an input dismissing the report. If dismissal has been received 606, the method 600 may end with respect to the received 602 notification.

In some embodiments, fraudulent or frivolous reports of out of stock products may be prevented by imposing a limit on the number of out of stock notifications that will be processed according to methods described herein for a particular customer, customer device 104a, 104b, or customer account. In such embodiments, dismissal of a report due to excess number of notifications may be dismissed prior to providing notification to an employee or taking other action in accordance with the method 600.

In some embodiments, in order to generate a notification that a product is out of stock, a user may additionally be required to take a picture of the shelf, or other location, where a product should be stocked. The picture may then be submitted by the user computing device with the notification. In some embodiments, the picture may be taken in the context of a merchant application that validates the time at which the picture was taken. In other embodiments, the picture may be inherently or automatically time stamped and this time stamp used to validate the notification. In view of the foregoing, execution of the method 600 by a server system 102, or other computer system, may be preceded by validation of a picture submitted with the notification. Validating the picture may include validating the time stamp for the photo as well as automatically analyzing the picture in order to locate the optical code 304 as well as verify absence of the product corresponding to the optical code 304 in the image. Where analysis of the submitted picture does not validate the notification, the notification may be dismissed and further execution of the method 600 may end.

The method 600 may include evaluating whether notification of restocking has been received 608. If so, then notification of restocking may be transmitted 610 to one or more user computing devices corresponding to customers that reported the product out of stock. A reward for reporting a product out of stock may also be associated 612 with user-accounts or user devices associated with one or more notifying customers. In some embodiments, an amount of reward may in accordance with the order in which notifications were received. For example, at a given store at a given time, a set of notifications may be received in temporal proximity for the same product, e.g. within N minutes of one another. The reward associated with each notifying customer for a set of notifications may correspond to the order in which the notifications were received. For example, a first reporting customer may receive a reward of higher value or more points than a subsequently reporting customer in the set.

In some embodiments, a current location of one or more notifying customers may be transmitted to the employee computing devices. In such embodiments, a notification of restocking may additionally or alternatively include receiving notification from an employee computing device of hand delivery of the product to one or more notifying customers. In some embodiments, a customer computing device 104a, 104b may be provided with an interface element enabling a customer to acknowledge hand delivery of the product. In such embodiments, the method 600 may include receiving this acknowledgment and clearing or otherwise recording resolution of the out-of-stock notification received 602.

Where a notification of restocking of the product if found 608 not to have been received, a product is otherwise found not to be available in inventory, or an input received from an employee computing device indicates that restocking is not possible, the method 600 may include evaluating 614 whether the product is available at a proximate location, e.g. a nearby store or warehouse. If so, then notification of availability of the product may be transmitted 616 to one or more notifying customers. The notification may include such information as an address of the proximate location, directions to the proximate location, distance to the proximate location or other information.

Where no proximate availability is found 614, the method 600 may include creating 618 a flag or other record of the received 602 OOS notification. The record may include user identifiers for one or more notifying customers, a location of a store or stores close to the customer, a time the notification was received, or other information. When inventory for the product is subsequently detected at the location or proximate the location associated with the flag, notification thereof may be transmitted to a user computing device 104a, 104b associated with the notifying customer or customers identified in the flag. In some embodiments, where no dismissal of an OOS notification was received, a reward may be associated 612 with accounts of notifying customers as described above.

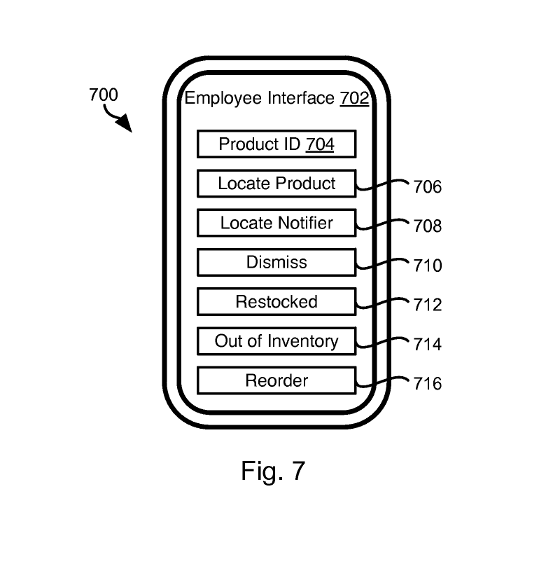

FIG. 7 illustrates an employee computing device 700, such as a mobile phone, tablet computer, or other computing device having some or all of the attributes of the computing device 200. The employee computing device 700 may display and receive inputs from an employee interface 702. For example, upon receiving notification that the notifying customer has sent an OOS report for a product, the employee interface 702 may display some or all of the illustrated information and interface elements. For example, the employee interface 702 may display a product identifier 704 that may include such information as the name of the product and an image of the product.

The interface 702 may include an interface element 706 to invoke display of a location of a product in inventory, if available. The interface 702 may interface, for example, with an inventory management system associated with a store or merchant in order to retrieve this information. The interface element 706 may invoke display of directions to a location of available products or a map showing the location of available instances of the product.

The interface 702 may include an interface element 708 operable to invoke display of a current location of the notifying customer. For example, a user computing device 104a, 104b may include a GPS or other location system. A merchant application or other application executing on the user computing device 104a, 104b may transmit a current location of the user computing device 104a, 104b for a period following transmission of an OOS notification to enable an employee to find the notifying customer in order to hand deliver the product identified in the OOS notification. This period may end upon detecting departure of the customer from the store where the notification was first transmitted, the parking lot of the store, or some other geographic area. Accordingly, by selecting the interface element 708, an employee may invoke display of this reported location, such as superimposed on a map of a store, in order to find the notifying customer and hand deliver the product.

The interface 702 may include an interface element 710 to invoke dismissal of an OOS notification. This interface element 710 may be invoked when an employee determines that a report was in error or fraudulent.

The interface 702 may include an interface element 712 that, when selected, invokes transmission of notification of restocking of the product identified in an OOS notification. The notification of restocking may be transmitted to a server system and/or directly to the notifying customer.

The interface 702 may include an interface element 714 that, when selected, invokes transmission of notification that the product is not available in inventory. This notification may be transmitted to a server system 102 or other computer system executing the method 600. The notification that a product is out of stock may also be transmitted directly to a customer computing device 104a, 140b of the notifying customer.

The interface 702 may include an interface element 716 that, when selected, invokes reordering of the product for delivery to the store for which the OOS notification was received. The interface element 716 may receive, or invoke an interface for receiving, reordering information such as a quantity and a delivery date.

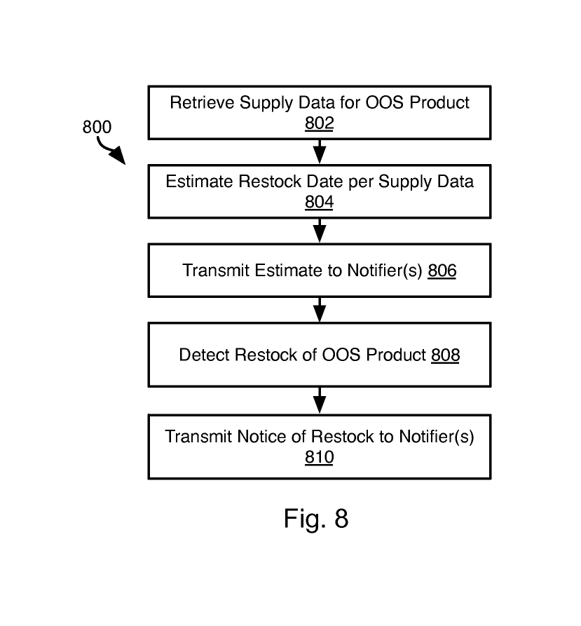

FIG. 8 illustrates a method 800 that may be invoked when a product that is the subject of an out-of-stock notification is one or both of not available at a store where a notifying customer is located and a proximate location. The method 800 may include retrieving 802 supply data for an out-of-stock (OOS) product according to an OOS notification received from a customer computing device 104a, 104b. The supply data retrieved 802 may include such information as a reorder schedule for the product, a pending order for the product, or other data describing the ordering and inventory levels for a product. The supply data retrieved 902 may include data describing inventory levels at nearby warehouses or stores from which the product could be delivered to the store for which the method 800 has been invoked.

Using this supply data 804, a date and/or time at which the product will be restocked may be estimated 804. And the estimated date and/or time when the product will be one or both available in the inventory of the store or stocked on a shelf or other location where the product is made available to customers may be transmitted 806 to one or more notifying customers that invoked execution of the method 800 with an OOS notification.

The method 800 may further include detecting 808 restocking of the product and transmitting 810 notice of actual restocking to the notifying customers, i.e. to user computing devices 104a, 140b of the notifying customers. Detecting 808 restocking may include detecting data in a supply chain management database or system indicating that inventory for the product is available at the store or receiving an express indication of available inventory from an employee at the store.

The invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A method for stocking shelves, the method comprising:
providing at a first location a plurality of optical codes affixed to shelves, each optical code of the plurality of optical codes corresponding to a product positioned adjacent the each optical code when stocked;
receiving, by a computer system, from a user computing device, notification of scanning of a scanned optical code of the plurality of optical codes, the notification indicating a product corresponding the scanned optical code is not stocked adjacent the scanned optical code; and
in response to receipt of the notification of scanning of the scanned optical code, associating, by the computer system, a reward with a user account associated with the user computing device.

2. The method of claim 1, further comprising transmitting notification of the reward to the user computing device.

3. The method of claim 1, wherein receiving, by the computer system, from the user computing device, notification of scanning of the scanned optical code of the plurality of optical codes comprises receiving a first notification of scanning of the scanned optical code from a first a first user computing device, the method further comprising:
receiving one or more second notifications of scanning of the scanned optical code from one or more second user computing devices;
wherein associating, by the computer system, the reward with the user account associated with the user computing device further comprises:
associating rewards with user accounts associated with the first user computing device and the one or more second user computing devices in accordance with an order of receipt of the first notification and one or more second notifications.

4. The method of claim 1, wherein the reward is points defined and used in accordance with game logic.

5. The method of claim 1, wherein the reward is a promotion for the product corresponding to the scanned optical code.

6. The method of claim 1, further comprising:
transmitting, by the computer system, a message identifying the product associated with the scanned optical code to an employee computing device.

7. The method of claim 6, further comprising, receiving, by the computer system, a message from the employee computing device indicating one of:
restocking of the product corresponding to the scanned optical code; and
a lack of inventory of the product corresponding to the scanned optical code.

8. The method of claim 7, further comprising transmitting notice of the message received from the employee computing device to the user computing device.

9. The method of claim 7, further comprising:
if the message indicates a lack of inventory of the product corresponding to the scanned optical code, evaluating, by the computer system, whether inventory of the product corresponding to the scanned optical code is available at a proximate location proximate to the first location; and
if inventory of the product corresponding to the scanned optical code is found to be available at the proximate location, transmitting, by the computer system, notice of the proximate location to the user computing device.

10. The method of claim 9, further comprising:
if inventory of the product corresponding to the scanned optical code is not found to be available at the proximate location, transmitting, by the computer system, to the user computing device, notice of availability of the product corresponding to the scanned optical code upon detecting availability of the product corresponding to the scanned optical code at at least one of the first location and the proximate location.

11. A system for stocking shelves, the system comprising:
a plurality shelves having a plurality of optical codes affixed thereto, each optical code of the plurality of optical codes corresponding to a product positioned adjacent the each optical code when stocked;
one or more processors and one or more memory devices operably coupled to the one or more processors, the one or more memory devices storing executable and operational code effective to cause the one or more processors to:
receive from a user computing device, notification of scanning of a scanned optical code of the plurality of optical codes, the notification indicating a product corresponding the scanned optical code is not stocked adjacent the scanned optical code; and
in response to receipt of the notification of scanning of the scanned optical code, associate a reward with a user account associated with the user computing device.

12. The system of claim 11, wherein the executable and operational data are further effective to cause the one or more processors to transmit notification of the reward to the user computing device.

13. The system of claim 11, wherein the executable and operational data are further effective to cause the one or more processors to receive, from the user computing device, notification of scanning of the scanned optical code of the plurality of optical codes by receiving a first notification of scanning of the scanned optical code from a first a first user computing device;
wherein the executable and operational data are further effective to cause the one or more processors to receive one or more second notifications of scanning of the scanned optical code from one or more second user computing devices;
wherein the executable and operational data are further effective to cause the one or more processors to associate the reward with the user account associated with the user computing device by associating rewards with user accounts associated with the first user computing device and the one or more second user computing devices in accordance with an order of receipt of the first notification and one or more second notifications.

14. The system of claim 11, wherein the reward is points defined and used in accordance with game logic.

15. The system of claim 11, wherein the reward is a promotion for the product corresponding to the scanned optical code.

16. The system of claim 11, wherein the executable and operational data are further effective to cause the one or more processors to:
transmit a message identifying the product associated with the scanned optical code to an employee computing device.

17. The system of claim 16, wherein the executable and operational data are further effective to cause the one or more processors to receive a message from the employee computing device indicating one of:
restocking of the product corresponding to the scanned optical code; and
a lack of inventory of the product corresponding to the scanned optical code at the first location.

18. The system of claim 17, wherein the executable and operational data are further effective to cause the one or more processors to transmit notice of the message received from the employee computing device to the user computing device.

19. The system of claim 17, wherein the executable and operational data are further effective to cause the one or more processors to:
if the message indicates a lack of inventory of the product corresponding to the scanned optical code, evaluate whether inventory of the product corresponding to the scanned optical code is available at a proximate location proximate to the first location; and
if inventory of the product corresponding to the scanned optical code is found to be available at the proximate location, transmit notice of the proximate location to the user computing device.

20. The system of claim 19, wherein the executable and operational data are further effective to cause the one or more processors to:
if inventory of the product corresponding to the scanned optical code is not found to be available at the proximate location, transmit to the user computing device notice of availability of the product corresponding to the scanned optical code upon detecting availability of the product corresponding to the scanned optical code at at least one of the first location and the proximate location.
